(19) United States
(12) Patent Application Publication
(10) Pub. No.: US 2026/0205168 A1
(43) Pub. Date: Jul. 16, 2026

(54) UNIVERSAL MASSIVE MULTIPLE INPUT MULTIPLE OUTPUT (MIMO) ARCHITECTURE FOR WIRELESS COMMUNICATIONS

(71) Applicant: The Regents of the University of California, Oakland, CA (US)

(72) Inventors: Adel Heidari, La Jolla, CA (US); Agrim Gupta, La Jolla, CA (US); Ish Jain, La Jolla, CA (US); Dinesh Bharadia, La Jolla, CA (US)

(21) Appl. No.: 19/450,613

(22) Filed: Jan. 15, 2026

Related U.S. Application Data
(60) Provisional application No. 63/745,600, filed on Jan. 15, 2025.

(51) Int. Cl. H04B 7/0452

(52) U.S. Cl. CPC H04B 7/0452

(57) ABSTRACT

Systems and methods directed to universal massive MIMO beamforming architectures are disclosed. An example wireless communication system includes a digital precoder configured to receive user data streams and generate digitally precoded signals; a sample interleaver configured to combine these signals into a single interleaved signal sequence; a single RF chain, which includes a digital-to-analog converter operating at a sampling frequency that is a multiple of a base sampling frequency that corresponds to virtual RF chains, configured to convert this sequence to an analog signal; an analog precoder that includes fast phase shifters, each associated with an antenna and configured to apply a time-variant phase shift pattern cycling through phase values within a symbol period; and an air interface that includes, for each antenna, a bandpass filter, power amplifier, and antenna.

### CROSS-REFERENCE TO RELATED APPLICATION

This patent document claims priority to and the benefit of U.S. Provisional Patent Application 63/745,600, entitled “PHASEMO: FUTURE-PROOF, ENERGY-EFFICIENT, ADAPTIVE MASSIVE MULTIPLE INPUT MULTIPLE OUTPUT (MIMO),” filed on Jan. 15, 2025. The entire content of the aforementioned patent application is incorporated by reference as part of the disclosure of this patent document.

### STATEMENT REGARDING FEDERALLY SPONSORED RESEARCH

This invention was made with government support under 2211805 and 2030245 awarded by the National Science Foundation. The government has certain rights in the invention.

### TECHNICAL FIELD

This patent document is generally related to wireless communication in cellular networks, and more particularly, to using massive multiple input multiple output (MIMO) beamforming architectures in cellular networks for wireless communication.

### BACKGROUND

Wireless communication systems have evolved through successive generations to accommodate increasing numbers of connected devices and growing data traffic demands. Each generation of cellular technology has incorporated additional antennas to access spatial degrees of freedom, providing benefits such as increased coverage, higher throughput, and spatial multiplexing capabilities to support large numbers of users.

Massive MIMO technology represents a multi-antenna approach that utilizes a large number of antennas, which can range from 64 to 128 or more, to provide extended coverage areas, high net throughputs, and the ability to spatially multiplex multiple users simultaneously. These systems can achieve coverage distances exceeding one kilometer, net throughputs over one gigabit per second, and spatial multiplexing of eight to sixteen users.

### SUMMARY

Embodiments of the disclosed technology provide methods, devices, and systems relating to a universal multi-antenna architecture that is referred to as PhaseMO. Compared to the state-of-art radios, which either use static phase shifters, and/or separate multiple digital interfaces per antenna (e.g., analog-to-digital converters (ADCs) or digital-to-analog converters (DACs)), PhaseMO utilizes FPSs to create maximum analog gain across multiple digital time slots sampled by a single ADC/DAC interface. This helps PhaseMO reduce power consumption and cost by minimizing the number of ADC/DACs.

As described in this patent document, PhaseMO allows each antenna in a multi-antenna architecture to be controlled via an analog phase shifter, referred to herein as a fast phase shifter (FPS), that can be toggled at nano-second timescales. In some implementations, PhaseMO utilizes FPS backed antenna arrays that can reduce power consumption and implementation complexity of massive MIMO (Multiple Input Multiple Output) arrays. In other implementations, PhaseMO is implemented by co-phasing a large number of antennas at sub-sample time levels by aid of fast phase shifter units connected to each antenna and controlled efficiently. The disclosed technology may find applications in low-power and low-cost 5G base stations, among other applications.

In an example aspect, a system for wireless communication is disclosed. The system includes an interleaver, a single radio frequency (RF) chain that includes a single DAC, a plurality of phase shifters, and a plurality of bandpass filters. In this system, the interleaver is configured to receive a first plurality of data vectors and perform, at a base sampling frequency, a sample interleaving operation thereon to generate a plurality of interleaved digital samples. The single DAC is configured to convert, at a multiple of the base sampling frequency, the plurality of interleaved digital samples into a plurality of analog samples, and the multiple corresponding to a number of virtual RF chains. Moreover, each bandpass filter is configured to perform a filtering operation on an output of a corresponding phase shifter and generate a corresponding plurality of output samples for transmission using an antenna, each phase shifter is configured to receive the plurality of analog samples and apply a time-variant phase shift pattern thereto, and the time-variant phase shift pattern cycles through a plurality of phases within a symbol time, wherein a number of the plurality of phases is equal to the number of virtual RF chains.

In another example aspect, a method of wireless communication is disclosed. The method includes receiving a plurality of data vectors corresponding to a number of users, performing a digital precoding operation on the plurality of data vectors to generate a plurality of precoded signals, performing a sample interleaving operation on the plurality of precoded signals to generate a single interleaved signal, and performing, using a single RF chain, a DAC operation on the single interleaved signal to generate an analog signal. Herein, the sample interleaving operation is performed at a base sampling frequency, the DAC operation is performed at a multiple of the base sampling frequency, and the multiple corresponds to a number of virtual RF chains. The method further includes performing an upconversion operation on the analog signal to generate a modulated signal, performing, using a plurality of phase shifters, a plurality of phase shifting operations on the modulated signal to generate a plurality of phase-shifted signals, performing a bandpass filtering operation on the corresponding phase-shifted signal to generate a corresponding filtered signal of a plurality of filtered signals, and amplifying and radiating, using each of a plurality of antennas, the corresponding filtered signal. Furthermore, each phase shifting operation comprises applying a time-variant phase shift pattern to the modulated signal to generate a corresponding phase-shifted signal of the plurality of phase-shifted signals, the time-variant phase shift pattern cycles through a plurality of phases within a symbol time, and a number of the plurality of phases is equal to the number of virtual RF chains.

In yet another example aspect, a communication apparatus (e.g., a base station) is disclosed. The base station includes at least one processor coupled to a memory, and the at least one processor being configured to receive a plurality of data vectors corresponding to a plurality of user equipment, perform a digital precoding operation on the plurality of data vectors to generate a plurality of precoded signals, and perform a sample interleaving operation on the plurality of precoded signals to generate a single interleaved signal. The at least one processor is further configured to perform, based on controlling a single RF chain, a DAC operation on the single interleaved signal to generate an analog signal, and perform an upconversion operation on the analog signal to generate a modulated signal. Herein, the sample interleaving operation is performed at a base sampling frequency, the DAC operation is performed at a multiple of the base sampling frequency, the multiple corresponds to a number of virtual RF chains, and the upconversion operation comprises shifting a frequency of the analog signal from a baseband frequency to a carrier frequency. The at least one processor is further configured to perform, based on controlling a plurality of phase shifters, a plurality of phase shifting operations on the modulated signal to generate a plurality of phase-shifted signals, perform a bandpass filtering operation on the corresponding phase-shifted signal to generate a corresponding filtered signal of a plurality of filtered signals, and controlling each of a plurality of antennas to amplify and radiate the corresponding filtered signal. In this communication apparatus, each phase shifting operation comprises applying a time-variant phase shift pattern to the modulated signal to generate a corresponding phase-shifted signal of the plurality of phase-shifted signals, the time-variant phase shift pattern cycles through a plurality of phases within a symbol time, and a number of the plurality of phases is equal to the number of virtual RF chains.

Disclosed herein are example embodiments related to PhaseMO, which enables flexible reduction of power, adaptation to network load akin to antenna muting, and the ability to use the entire antenna array similar to the hybrid beamformer, while reducing the RF chains. In some example embodiments, the total digital compute can be optimized using software control to reduce the total number of RF chains, while always being connected to all the antennas using disclosed analog network architectures. Implementations of PhaseMO can enable maximum utilization of all the antennas' spatial degrees of freedom to avail the maximum beamforming gain while reducing the digital processing power demanded by RF chains. This allows PhaseMO to operate at higher energy efficiencies than the existing solutions without creating any adverse effects on throughput, coverage, and user device power consumption.

In yet another example aspect, a transmitter and a receiver that implement PhaseMO are disclosed. On the transmit-side, multiple transmit streams are coded in baseband to form one stream, each stream having its own unique code. The combined stream is connected to antennas with inverting analog logic, and the inverse of that coding is implemented in the analog domain using delay, phase, and amplitude controls. The antennas are configured to transmit to multiple users. On the receive-side, multiple antennas receive streams that are coded in the analog domain using delay, phase, and amplitude controls. Then all these analog signals are combined and sampled using single ADC. The coding is inverted in the digital domain to recover a digital signal corresponding to the stream received on a corresponding antenna. Additionally, on the transmit-side, additional mixers, up conversion modules, power amplifiers, and/or bandpass filters can be included. Furthermore, the analog coding on the transmit-side is implemented using amplitude, phase, delay or filters to remove out of band leakage. This disclosed systems can achieve analog, hybrid, and full-digital beamforming architectures with a single architecture, which is energy and cost efficient.

In yet another example aspect, an apparatus comprising a memory and a processor that implements the above-described methods is disclosed.

In yet another example aspect, the above-described methods may be embodied as processor-executable code and may be stored on a non-transitory computer-readable program medium.

The above and other aspects and features of the disclosed technology are described in greater detail in the drawings, the description and the claims.

### BRIEF DESCRIPTION OF THE DRAWINGS

FIG. 1 illustrates a block diagram of a generic beamforming architecture for a wireless communication system.

FIGS. 2A and 2B illustrate block diagrams of a traditional beamforming architecture and an example PhaseMO beamforming architecture, respectively.

FIG. 3 illustrates a block diagram of an example PhaseMO system architecture for wireless communications.

FIG. 4 illustrates an evaluation framework for testing beamforming architectures using channel simulation.

FIG. 5 illustrates a graph showing throughput performance as a function of distance for various beamforming architectures.

FIGS. 6A and 6B illustrate graphs comparing power consumption and throughput performance, respectively, between antenna muting with digital beamforming and PhaseMO.

FIG. 7A illustrates a graph comparing energy efficiency as a function of active RF chains for different beamforming techniques.

FIG. 7B illustrates a graph showing energy efficiency improvement as a function of the number of users.

FIGS. 7C and 7D illustrate graphs showing coverage reduction comparison and user equipment transmit power increase comparison, respectively, between antenna muting with digital beamforming and PhaseMO.

FIGS. 8A and 8B are flowcharts of example methods of wireless communication.

FIG. 9 illustrates an example hardware platform configured to implement one or more methods and/or embodiments described in this patent document.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Wireless communication systems have advanced through successive generations to address the increasing number of connected devices and the growing demand for data traffic. Each generation of cellular technology has integrated additional antennas to exploit spatial degrees of freedom, resulting in enhanced coverage, higher throughput, and improved spatial multiplexing capabilities to support larger user populations. Building on these advancements, massive multiple-input multiple-output (MIMO) technology employs a substantial number of antennas—typically ranging from 64 to 128 or more—to deliver extended coverage areas, high net throughputs, and the ability to spatially multiplex multiple users simultaneously. As a result, massive MIMO systems are capable of achieving coverage distances exceeding one kilometer, net throughputs greater than one gigabit per second, and spatial multiplexing for eight to sixteen users at the same time.

As cellular networks mature and evolve, software-based control over radio hardware has emerged as a theme for network management. Software-based control provides flexibility over hardware operation and can reduce operational expenditure by adjusting power consumption when network conditions do not require peak performance. In the context of massive MIMO, such software-based control aims to utilize spatial degrees of freedom to optimize for existing network load conditions. For example, a massive MIMO base station may reduce the number of spatially multiplexed layers under low load conditions, such as during nighttime hours, to save power while maintaining the ability to return to peak performance when network load increases.

Existing approaches for adapting massive MIMO systems to network load conditions include antenna muting combined with digital beamforming and hybrid beamforming architectures. Digital beamforming architectures maintain a separate digital RF chain interface for each antenna, and antenna muting approaches provide software-based control to turn off a certain number of RF chains when network load is low. While antenna muting can improve energy efficiency by reducing the number of active antennas, this approach can lead to reduced user-perceived throughput and increased user equipment power consumption due to reduced overall antenna gain.

Hybrid beamforming architectures aim to utilize a large number of antennas while connecting them to a smaller number of RF chains through an analog network that includes phase shifters. Since hybrid beamforming does not reduce the number of antennas but rather the number of RF chains, it may avoid some of the throughput and user device power impacts associated with antenna muting. However, hybrid beamforming architectures can present challenges in terms of flexibility and scalability. For instance, a hybrid beamformer designed to connect 64 antennas to 8 RF chains may not be readily scaled to support 16 spatially multiplexed layers using the same hardware, which can limit deployment options.

Other antenna array approaches utilize RF switches to multiplex multiple antennas through a single RF chain using time domain codes. However, commercially available RF switches may be limited in switching speeds, which can constrain the number of antennas that can share the same RF chain. Additionally, RF switches may provide antenna-selection-based beamforming gains that do not capture the full beamforming gains achievable through co-phased combining across antennas.

To address these drawbacks, embodiments of the disclosed technology provide PhaseMO, a versatile approach that adapts to varying network loads. PhaseMO effectively reduces power consumption in low-load scenarios without sacrificing coverage and overcomes the hardware limitations of hybrid beamforming, offering a scalable and future-proof solution. Simulation results evince PhaseMO achieving up to 30% improvement in energy efficiency while avoiding about 10% coverage reduction and a 5 dB increase in UE transmit power.

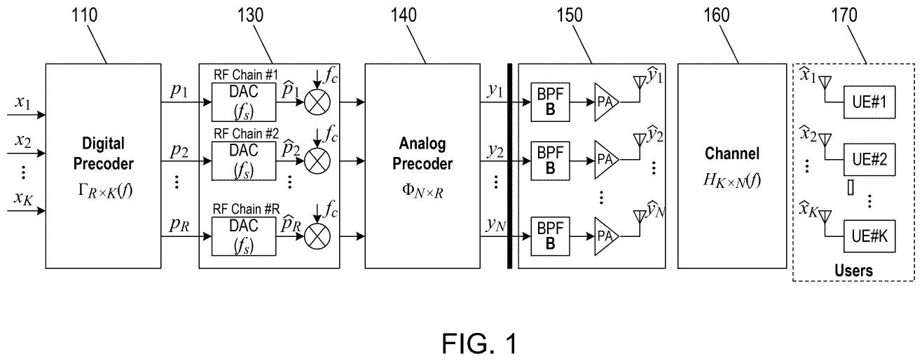

FIG. 1 illustrates a generic architecture model for beamforming structures in a wireless communication system. As shown therein, the architecture model encompasses several functional parts that process and transmit signals from a base station to multiple users. The architecture includes a baseband digital precoder 110, RF chains 130, an analog precoder 140, and an air interface part 150.

The baseband digital precoder 110 receives user data vectors X_{K×1}(f) from K users and performs digital precoding over subcarriers. The digital precoder 110 applies a precoding matrix Γ_{R×K}(f) to the users' data vector, which has a specified bandwidth B. The digital precoding operation generates R precoded signals P_{R×1}(f)=Γ_{R×K}(f) X_{K×1}(f), with each precoded signal corresponding to an RF chain. In some cases, the digital precoder 110 may use 64-QAM constellation points for user data modulation, providing a modulation scheme that maps user bits to constellation symbols for transmission.

With continued reference to FIG. 1, the RF chains section 130 receives the precoded digital samples and processes the precoded digital samples through digital-to-analog converters (DACs) operating at a sampling frequency fₛ. Each RF chain includes an upconverter that shifts the baseband signal to a passband at a carrier frequency f_{c}, resulting in analog output signals \grave{P}_{R×1}(f). The RF chains 130 convert the digitally precoded symbols into analog signals for further processing. The DAC output may include non-idealities such as sideband images near harmonics of the sampling frequency, which may be modeled with a function A. In some cases, the system may use orthogonal frequency division multiplexing (OFDM) symbols with 100 MHz bandwidth and 64 subcarriers for signal transmission.

The analog precoder 140 follows the RF chains 130 and comprises a network of phase shifters that perform analog precoding on the passband signal. The analog precoding matrix Φ_{N×R} consists of unity magnitude components with varying phases and maps the R RF chains' analog signals to N output signals Y_{N×1}(f)=Φ_{N×R} A(Γ_{R×K}(f) X_{K×1}(f)) that are radiated from antennas. The analog precoder 140 connects the RF chains 130 to the antennas in the air interface part 150.

As further shown in FIG. 1, the air interface part 150 includes bandpass filters, power amplifiers, and antennas. The bandpass filters, placed before the power amplifiers, remove non-idealities from the DAC, upconverter, and other sources. The bandpass filters have a bandwidth B centered at the carrier frequency f_{c} and process the signals Y_{N×1}(f) to produce filtered output signals \grave{Y}_{N×1}(f). Using the bandpass filter, the non-idealities sourced from the DAC shown with function A may be eliminated. The power amplifiers amplify the filtered signals before transmission through the antennas.

The emitted signal from the antennas may be expressed as:

$${{Y}^{‵}}_{N \times 1} ( f ) = {Φ}_{N \times R} {Γ}_{R \times K} ( f ) {X}_{K \times 1} ( f ) .$$

Herein, Φ_{N×R} is the analog precoding matrix for N antennas and R physical RF chains, Γ_{R×K}(f) is the digital precoding matrix, and X_{K×1}(f) is the data for K user streams.

The received signals on the user side may be determined by considering the channel effect on the emitted signals. The received signal equation may be expressed as:

$${{X}^{‵}}_{K \times 1} ( f ) = {H}_{K \times N} ( f ) {Φ}_{N \times R} {Γ}_{R \times K} ( f ) {X}_{K \times 1} ( f )$$

Herein, H_{K×N}(f) is the wireless channel matrix between N antennas and K users. The wireless channel matrix characterizes the wireless channel between the antennas at the base station and the users, accounting for path loss, fading, and other propagation effects.

In digital beamforming architecture, all precoding is performed on the digital symbols, eliminating the need for an analog precoder. As a result, the number of RF chains equals the number of antennas, implying R=N. Consequently, the analog precoding matrix Φ_{N×R} reduces to the identity matrix I_{N×N}, and the digital precoding matrix Γ_{R×K}(f) becomes ΓN×K(f). The emitted signal from the antennas in digital beamforming may be expressed as \grave{Y}_{N×1}(f)=Γ_{N×K}(f) X_{K×1}(f). Digital beamforming provides frequency-dependent precoding across subcarriers, enabling wideband system optimization. In some cases, an antenna array may be configured to support 64-128 antennas for massive MIMO deployments using digital beamforming architecture.

Analog beamformers are structurally different from digital beamformers and do not utilize any digital precoder. Instead, a single RF chain is employed to convert digital symbols into an analog signal, limiting the architecture to support data transmission for one user at a time (R=K=1, X_{K×1}(f)=X_{1×1}(f), and Γ_{1×1}=1). In the analog domain, a network of phase shifters is used for precoding. The network comprises as many phase shifters as there are antennas (N) in the architecture, resulting in the analog precoder matrix being an N×1 vector. The emitted signal for analog beamforming may be expressed as Y_{N×1}(f)=Φ_{N×1} X_{1×1}(f). However, the precoding performance is limited since the analog precoding matrix Φ_{N×1} is not frequency-dependent, reducing effectiveness for wideband systems.

Hybrid beamforming combines a digital precoder and an analog beamformer. The hybrid beamforming architecture features R radio frequency (RF) chains that convert digitally precoded symbols Γ_{R×K}(f) into analog signals, which are then beamformed via a phase shifter network and radiated from N antennas. The analog network may be fully connected, in which all R RF chains connect to all N antennas, or partially connected, in which each RF chain connects to a subset of antennas. The emitted signal for hybrid beamforming may be expressed as \grave{Y}_{N×1}(f)=Φ_{N×R} τ_{R×K}(f) X_{K×1}(f), where Φ_{N×R} has sparse non-zero elements in partially connected architectures. The maximum number of users supported is limited by the number of RF chains R. In some cases, the system may support spatial multiplexing of 8-16 users in the spatial domain. The analog precoder Φ_{N×R}, not being frequency-dependent, reduces performance in wideband systems.

Existing antenna muting approaches consist of softwarized control atop digital beamformers, which turn off a certain number of RF chains when network load is low. Antenna muting adjusts the number of antennas as network load varies to improve energy efficiency by not using more than the required number of antennas. However, antenna muting leads to reduced user-perceived throughput as well as increased user equipment power, since overall antenna gain reduces due to muting. The reduction in active antennas causes adverse effects on throughput and coverage.

Hybrid beamforming architectures are not flexible and future-proof. For example, a hybrid beamformer that connects 64 antennas to 8 RF chains cannot be scaled up to utilize the same hardware for 16 spatially multiplexed layers. Hybrid beamforming architectures may be designed for a particular network load and are unable to scale up if needed in the future, which limits real-world deployment. Fully-connected hybrid beamforming captures maximum array gain per RF chain but has challenges in hardware implementations since fully-connected hybrid beamforming requires complex analog networks with multiple splitter networks to ensure all antennas are available to all RF chains.

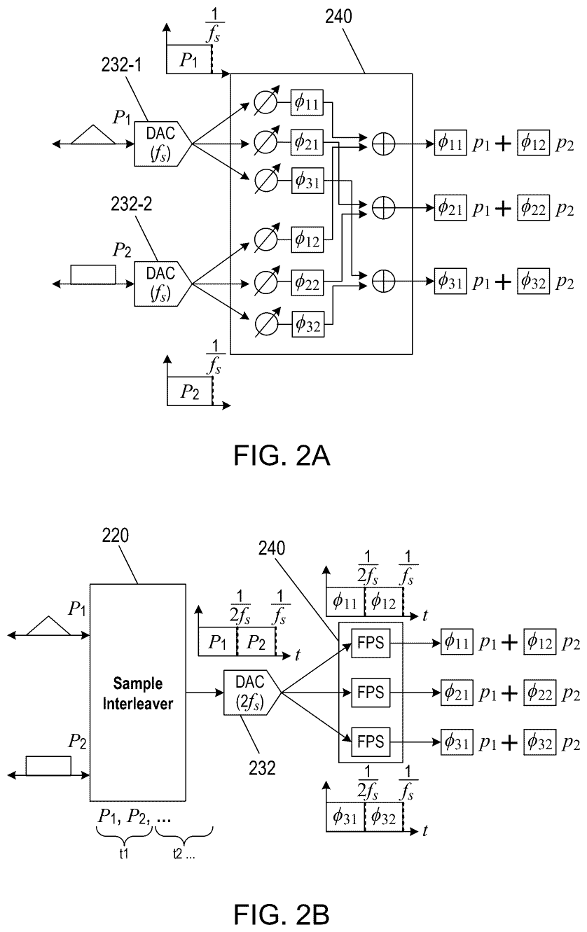

FIG. 2A shows a traditional beamforming architecture. As shown therein, the traditional beamforming architecture utilizes multiple RF chains, where each RF chain corresponds to a precoded signal. In the illustrated example, the traditional beamforming architecture includes a first precoded signal P₁ and a second precoded signal P₂, with each precoded signal passing through a respective digital-to-analog converter (DAC) operating at a sampling frequency fₛ (e.g., DACs 232-1 and 232-2, respectively). The DAC outputs are then connected to time-invariant phase shifters (collectively 240) at each antenna.

With continued reference to FIG. 2A, the phase shifters apply phase shifts to the precoded signals for beamforming purposes. For a configuration with three antennas, the phase shifters apply phase shifts (φ₁₁, φ₂₁, and φ₃₁ to the first precoded signal P₁ and phase shifts φ₁₂, φ₂₂, and Φ₃₂ to the second precoded signal P₂. Each antenna receives phase-shifted versions of both precoded signals from the respective phase shifters connected to that antenna.

The outputs from the phase shifters are combined at summing nodes to produce antenna signals for radiation from the antennas. The first antenna produces an output signal φ₁₁p₁+φ₁₂p₂, representing the summation of the phase-shifted first precoded signal and the phase-shifted second precoded signal. Similarly, the second antenna produces an output signal φ₂₁p₁+φ₂₂p₂, and the third antenna produces an output signal φ₃₁p₁+cp₃₂p₂. The combined signals at each antenna represent the superposition of the individually phase-shifted precoded signals.

As further shown in FIG. 2A, the timing diagram indicates that each precoded signal occupies a duration of 1/fₛ in the traditional architecture. The phase shifters in the traditional architecture are time-invariant, meaning that each phase shifter maintains a constant phase value during signal transmission. The traditional beamforming architecture requires a number of RF chains equal to the number of precoded signals, with each RF chain operating at the sampling frequency fₛ. For the illustrated example with two precoded signals and three antennas, the traditional architecture employs 3×2=6 time-invariant phase shifters to create the three antenna signals from the two RF chain outputs.

FIG. 2B shows an example of the PhaseMO architecture. As shown therein, the PhaseMO architecture combines all precoded signals into a single signal via a sample interleaver 220. In the PhaseMO architecture, the first precoded signal P₁ and the second precoded signal P₂ are fed into the sample interleaver 220, which organizes the precoded signals into an interleaved sequence. The sample interleaver 220 arranges the signals such that samples from the first precoded signal and the second precoded signal alternate at times t₁, t₂, and so forth, creating a combined signal stream from the multiple precoded inputs.

With continued reference to FIG. 2B, the sample interleaver 220 organizes V digitally precoded symbols by upsampling each vector by V and delaying each vector by 0, 1, 2, through V symbols respectively. For the illustrated example with two precoded signals (V=2), the sample interleaver 220 upsamples each precoded signal by a factor of two and applies appropriate delays to interleave the samples. The time domain interpretation of the interleaved signal may be expressed as z[n]=[p₁[1], p₂[1], p₁[2], p₂[2], . . . ], where pᵥ[m] denotes the m-th sample of the v-th digitally precoded time-domain vector.

The interleaved signal from the sample interleaver 220 passes through a single DAC 232 operating at a higher frequency of 2fₛ, which is twice the sampling frequency used in the traditional architecture. Each element in the interleaved vector occupies a time duration of 1/(2fₛ), so a single element delay in the vector acts as a 1/(2fₛ) time delay. The increased DAC sampling frequency compensates for the V-times upsampling performed by the sample interleaver 220.

As further shown in FIG. 2B, fast phase shifters (collectively 240) at each antenna beamform the combined analog signal from the single DAC. Each FPS alternates between two phase values at the DAC sampling frequency of 2fₛ. The first FPS alternates between phase values φ₁₁ and φ₁₂, the second FPS alternates between phase values φ₂₁ and φ₂₂, and the third FPS alternates between phase values φ₃₁ and φ₃₂. Each FPS holds each phase for a duration of 1/(2fₛ), synchronized with the interleaved samples from the DAC.

The FPS outputs produce antenna signals φ₁₁p₁+φ₁₂p₂, φ₂₁p₁+φ₂₂p₂, and φ₃₁p₁+φ₃₁p₂, which are equivalent to the antenna signals produced by the traditional architecture shown in FIG. 2A. By configuring the FPS components to shift the phase of signals in a specific pattern synchronized with the interleaved samples, the PhaseMO architecture creates the same signal outputs as the traditional architecture while using a single RF chain instead of multiple RF chains. The timing diagrams in FIG. 2B show that the interleaved samples occupy durations of 1/(2fₛ), with the phase shifters switching at corresponding intervals to apply the appropriate phase to each interleaved sample.

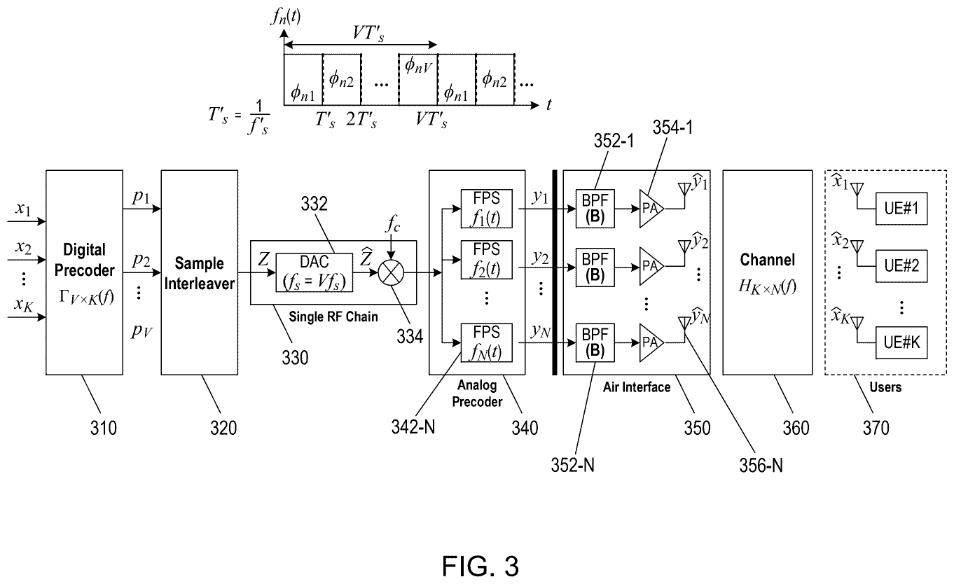

FIG. 3 shows a block diagram of an example PhaseMO system architecture. As shown therein, a PhaseMO system architecture for wireless communications is illustrated. The PhaseMO system includes a digital precoder 310, a sample interleaver 320, an RF chain 330, an analog precoder 340, and an air interface 350. The PhaseMO system transmits multiple data streams through a channel 360 to multiple users 370. The PhaseMO system architecture enables flexible reduction of power consumption adaptive to network load while maintaining the ability to use an entire antenna array.

The digital precoder 310 receives user data streams x₁, x₂, through x_{K} from K users and performs digital precoding operations using a matrix Γ_{V×K}(f) to generate V precoded signals p₁, p₂, through p_{V}. The digital precoder 310 applies baseband digital precoding across subcarriers to the users' data vector with bandwidth B. In some cases, the digital precoder 310 may apply Zero Forcing (ZF) equalization for digital precoding based on the channel per subcarrier derived from channel estimation feedback. The digital precoder 310 may use the center subcarrier channel phase as the analog beamforming approach for determining phase configurations.

With continued reference to FIG. 3, the sample interleaver 320 receives the V digitally precoded signals from the digital precoder 310 and organizes the V digitally precoded signals into a single interleaved sequence Z for processing by the RF chain 330. The sample interleaver 320 combines all V precoded signals by upsampling each signal by V and delaying each signal appropriately. The time domain interpretation of the interleaved signal output from the sample interleaver 320 may be expressed as z[n]=[p₁[1], p₂[1], . . . , p_{V}[1], p₁[2], p₂[2], . . . , p_{V}[2], . . . ], where pᵥ[m] denotes the m-th sample of the v-th digitally precoded time-domain vector.

The RF chain 330 includes a digital-to-analog converter (DAC) 332 and an upconverter 334. The DAC 332 operates at a sampling frequency fₛ′ equal to Vfₛ, where fₛ is the conventional beamforming sampling frequency, i.e., at a multiple of fₛ. The interleaved digital samples Z from the sample interleaver 320 pass through the DAC 332 for conversion to analog form. In some cases, the DAC 332 may operate at a maximum sampling frequency of 6.4 Gsps, which supports up to 64 antennas with 100 MHz over-the-air bandwidth. Once the interleaved signal passes through the DAC 332, each element in the interleaved vector occupies a time duration of 1/(Vfₛ), so a single element delay in the vector acts as a 1/(Vfₛ) time delay.

As further shown in FIG. 3, the upconverter 334 receives the analog output from the DAC 332 and shifts the baseband signal to a passband frequency f_{c}, resulting in an analog signal \grave{Z} with carrier frequency f_{c}. The upconverter 334 performs frequency translation to move the baseband signal to the appropriate carrier frequency for wireless transmission. The effect of V-times upsampling performed by the sample interleaver 320 is compensated by increasing the DAC 332 sampling frequency by V-times.

The analog precoder 340 follows the RF chain 330 and includes a plurality of fast phase shifters, with one FPS 342-n provided for each of the N antennas, with a last FPS 342-N denoted in FIG. 3. Each FPS 342-n generates a time-variant signal fₙ(t) that toggles periodically between V phases, with each phase held for a duration of 1/(Vfₛ). The FPS 342-n components collectively form the analog precoding matrix Φ_{N×V}, which maps the single RF chain 330 analog signal to N output signals y₁, y₂, through y_{N}. The analog precoder 340 receives the analog signal \grave{Z} from the upconverter 334 and applies time-variant phase shifts to generate the N antenna output signals.

Each FPS 342-n operates with voltage-controlled circuits that allow for high-speed phase changes in the order of 1 ns at symbol-level speeds. The high-speed phase change capability enables the FPS 342-n to switch between different phase values within a single symbol period, allowing the analog precoder 340 to apply different phase configurations to successive interleaved samples from the RF chain 330. In some cases, the FPS 342-n may have a modulation bandwidth limited to 2.5 GHZ, which restricts the number of antennas that may be interfaced using a particular circuit design.

The time-domain signal created by the FPS 342-n at the n-th antenna for one period may be expressed as:

$${f}_{n} ( t ) = {\sum }_{v = 0}^{V - 1} {e}^{j {Φ}_{n v}} {Π}_{{T}_{s}^{′}} ( t - v {T}_{s}^{′} - \frac{{T}_{s}^{′}}{2} ) .$$

Herein, fₙ(t) is the time-variant signal produced by the FPS 342-n at the n-th antenna, Φₙᵥ is the v-th phase produced by the n-th antenna FPS 342-n, and Π_{Ts} demonstrates a pulse with width of T'ₛ. The period VT'ₛ represents one complete cycle duration, and f'ₛ=Vfₛ is the DAC 332 sampling frequency of the PhaseMO system with respect to conventional beamforming sampling frequency fₛ.

The FPS 342-n at each antenna toggles periodically between (or cycles through) V phases, with each phase held for a duration of 1/(Vfₛ). For example, the FPS 342-n located at the n-th antenna creates phases Φₙ₁, Φₙ₂, through Φₙᵥ with a period of 1/fₛ. The periodic toggling of the FPS 342-n between the V phases is synchronized with the interleaved samples output from the DAC 332, such that each interleaved sample receives the appropriate phase shift corresponding to the virtual RF chain from which the sample originated.

The radiated signal from the n-th antenna may be determined as the multiplication of the constant periodic phases from the FPS 342-n and the DAC 332 output. The analog precoding matrix Φ_{N×V} represents the phase configurations of all N FPS 342-n components, where each column of the matrix corresponds to a different phase state and each row corresponds to a different antenna. The time-variant nature of the FPS 342-n enables the analog precoder 340 to apply V different phase configurations within a single symbol period, effectively creating V virtual RF chains from the single physical RF chain 330.

With continued reference to FIG. 3, the air interface 350 follows the analog precoder 340 and includes a bandpass filter 352-n, a power amplifier 354-n, and an antenna 356-n for each of the N signal paths. The bandpass filter 352-n has a bandwidth B centered at the carrier frequency f_{c} and removes non-idealities from the DAC 332, the upconverter 334-n, and spectral spreading effects from the FPS 342-n. The bandpass filter 352-n is placed before the power amplifier 354-n to remove non-idealities from the DAC 332, the upconverter 334, and other sources. In some cases, the bandpass filter 352-n may provide 40-45 dB adjacent channel power ratio (ACPR) attenuation for C-band communications.

The power amplifier 354-n receives the filtered signals from the bandpass filter 352-n and amplifies the filtered signals for wireless transmission. In some cases, the power amplifier 354-n may operate with 60% power efficiency. The power amplifier 354-n may provide 47 dB gain when combined with small pre-amplifiers to compensate for FPS-induced power spreading that attenuates the main band signal power. The antenna 356-n radiates the amplified signals from the power amplifier 354-n as output signals \grave{y}₁, \grave{y}₂, through \grave{y}_{N}.

In some cases, the antenna 356-n may be part of an antenna array comprising 64 antennas operating at 4.2 GHz center frequency. The air interface 350 may include the antenna 356-n positioned at a height of 35 meters for base station deployment. The system may operate with a maximum effective isotropic radiated power (EIRP) limit of 77 dBm.

The channel 360 represents the wireless propagation environment between the N antennas and the users 370. The channel 360 is characterized by a channel matrix H_{K×N}(f) between the N antennas and K users 370. The users 370 include user equipment UE #1, UE #2, through UE #K, which receive the transmitted signals.

The radiated signal from the antennas may be expressed as:

$${{Y}^{‵}}_{N \times 1} ( f ) = {Φ}_{N \times V} {Γ}_{V \times K} ( f ) {X}_{K \times 1} ( f ) .$$

Herein, Φ_{N×V} is the analog precoding matrix formed by the N FPS 342-n components, Γ_{V×K}(f) is the digital precoding matrix applied by the digital precoder 310, and X_{K×1}(f) is the data vector for K user streams.

The received signals at the users 370 may be determined by considering the channel 360 effect on the radiated signals. The received signal equation may be expressed as:

$${{X}^{‵}}_{K \times 1} ( f ) = {H}_{K \times N} ( f ) {Φ}_{N \times V} {Γ}_{V \times K} ( f ) {X}_{K \times 1} ( f )$$

Herein, H_{K>N}(f) is the wireless channel matrix between the N antennas and K users 370, accounting for path loss, fading, and other propagation effects in the channel 360.

The time-domain interpretation of the interleaved signal output from the sample interleaver may be expressed as z[n]=[p₁[1], p₂[1], . . . , p_{V}[1], p₁[2], p₂[2], . . . , p_{V}[2], . . . ], where pᵥ[m] denotes the m-th sample of the v-th digitally precoded time-domain vector. In the interleaved signal representation, all V vectors are upsampled by V and each vector is delayed by 0, 1, 2, through V symbols respectively. The interleaving operation combines the V precoded signals into a single stream by arranging samples from each precoded signal in an alternating sequence.

The frequency-domain representation of the interleaved signal in the analog domain may be derived by considering the time delays introduced by the interleaving operation. The frequency-domain representation of the sample interleaver output may be expressed as:

$$Z ( f ) = {P}_{1} ( f ) + {e}^{- \frac{j 2 π f}{V {f}_{s}}} {P}_{2} ( f ) + ⋯ + {e}^{- \frac{j ( V - 1 ) 2 π f}{V {f}_{s}}} {P}_{V} ( f ) .$$

Herein,

$${e}^{- \frac{j v 2 π f}{V {f}_{s}}}$$

represents the frequency-domain phase shift due to the time-domain delay for the v-th vector of precoded symbols. The exponential term accounts for the fractional symbol delay applied to each precoded signal during the interleaving process. The effect of V-times upsampling is compensated by increasing the DAC sampling frequency by V-times.

The radiated signal from the n-th antenna may be determined by considering the effect of the fast phase shifter on the DAC output. The radiated signal from the n-th antenna in the frequency domain may be expressed as:

$${{Y}^{‵}}_{n} ( f ) = {\sum }_{v = 0}^{V - 1} {e}^{j {Φ}_{n v}} ( {P}_{1} ( f ) + {e}^{- \frac{j 2 π f}{V {f}_{s}}} {P}_{2} ( f ) + ⋯ + {e}^{- \frac{j ( V - 1 ) 2 π f}{V {f}_{s}}} {P}_{V} ( f ) ) .$$

Herein, Φₙᵥ represents the v-th phase produced by the fast phase shifter at the n-th antenna. The summation over V phases accounts for the periodic toggling of the fast phase shifter between V different phase values within each symbol period.

To express the radiated signal in a more compact matrix form, a transformation may be applied to the precoded signals. By considering the transformation \grave{P}ᵥ(f)=Pᵥ(f)e^{jv2πf/(Vf}^{ₛ}⁾, the exponential delay terms may be incorporated into the transformed precoded signals. The transformation compensates for the frequency-dependent phase shifts introduced by the interleaving delays, allowing the radiated signal expression to be simplified.

Using the transformation, the summation in the radiated signal expression may be written in matrix form as:

$${{Y}^{‵}}_{N \times 1} ( f ) = {Φ}_{N \times V} {P}_{V \times 1} ( f ) .$$

Herein, Φ_{N×V} represents the phase matrix formed by N fast phase shifters, with each element of the matrix corresponding to a phase value applied by a particular fast phase shifter during a particular phase state. The transformed precoded signal vector \grave{P}_{V×1}(f) contains the V transformed precoded signals with the delay compensation applied.

The digital precoding matrix may be incorporated into the expression to relate the radiated signal to the original user data. By expressing \grave{P}_{V×1}(f)=Γ_{V×K}(f) X_{K×1}(f), where Γ_{V×K}(f) is the digital precoding matrix and X_{K×1}(f) is the user data vector, the complete radiated signal expression becomes:

$${{Y}^{‵}}_{N \times 1} ( f ) = {Φ}_{N \times V} {Γ}_{V \times K} ( f ) {X}_{K \times 1} ( f ) .$$

The matrix form expression demonstrates that the PhaseMO architecture applies both digital precoding through the matrix Γ_{V×K}(f) and analog precoding through the phase matrix Φ_{N×V} to generate the radiated signals from N antennas. The analog precoding matrix Φ_{N×V} has dimensions N×V, where N is the number of antennas and V is the number of virtual RF chains, with each element representing a phase value with unity magnitude.

The PhaseMO architecture provides adaptability to different beamforming modes through software control over the number of virtual RF chains V. The radiated signal expression \grave{Y}_{N×1}(f)=Φ_{N×V} Γ_{V×K}(f) X_{K×1}(f) may be configured to emulate different beamforming architectures by adjusting the value of V relative to the number of antennas N and the number of users K.
When V=N, the radiated signal equation becomes \grave{Y}_{N×1}(f)=Φ_{N×N} Γ_{N×K}(f) X_{K×1}(f). The equation with V=N is equivalent to digital beamforming when the analog precoding matrix Φ_{N×N} is configured as an identity matrix. The identity matrix configuration may be achieved by setting the phase values of each fast phase shifter such that no phase rotation is applied to the signals. In the digital beamforming mode, the PhaseMO architecture provides N virtual RF chains corresponding to N antennas, enabling full digital precoding capability across all antennas with frequency-dependent precoding across subcarriers.
When V=1, the radiated signal equation becomes \grave{Y}_{N×1}(f)=Φ_{N×1} X_{1×1}(f). The equation with V=1 is equivalent to analog beamforming, where a single RF chain drives all N antennas through the analog precoding matrix Φ_{N×1}. In the analog beamforming mode, the sample interleaver passes a single precoded signal without interleaving, and the DAC operates at the conventional sampling frequency fₛ. The fast phase shifters apply constant phase values without toggling between multiple phase states, since V=1 corresponds to a single phase configuration per symbol period. The analog beamforming mode supports data transmission for one user at a time with reduced digital processing requirements.
When V=R, where R represents an intermediate number of RF chains between 1 and N, the radiated signal equation becomes \grave{Y}_{N×1}(f)=Φ_{N×R} Γ_{R×K}(f) X_{K×1}(f). The equation with V=R is equivalent to hybrid beamforming, where R virtual RF chains are created from the single physical RF chain. In the hybrid beamforming mode, the sample interleaver combines R precoded signals into an interleaved sequence, and the DAC operates at a sampling frequency of Rfₛ. The fast phase shifters toggle between R phase values within each symbol period, applying R different phase configurations to the R interleaved samples. The hybrid beamforming mode supports up to R spatially multiplexed users while utilizing all N antennas for beamforming gain.

The adaptability of the PhaseMO architecture enables scaling the number of virtual RF chains V by increasing the DAC sampling rate by V times and running the fast phase shifters V times faster, without requiring hardware upgrades. The software control over V allows the PhaseMO architecture to adapt to varying network load conditions by adjusting the number of virtual RF chains to match the number of active users or spatial streams.

In some embodiments, a hybrid architecture may combine PhaseMO with sets of antennas, where each set of antennas is supported by a separate RF chain. The hybrid architecture enables scalability to higher numbers of antennas by distributing the antenna array across multiple PhaseMO subsystems, with each subsystem handling a subset of the total antennas. The hybrid architecture may address limitations in DAC sampling frequency and fast phase shifter modulation bandwidth that restrict the number of antennas that may be supported by a single RF chain.

In some embodiments, orthogonal cover codes (OCCs) may be used to enable more antenna channels from fewer ports for compliance with wireless communication standards. The orthogonal cover codes allow channel estimation procedures to map multiple antenna channels to fewer digital ports, enabling the PhaseMO architecture to operate within standard channel estimation frameworks that assume one antenna mapped to one digital port. The orthogonal cover codes provide a mechanism for the PhaseMO architecture to interface with existing wireless communication protocols while maintaining the reduced RF chain architecture.

The DAC output may include non-idealities that create sideband spectrums of the main signal at sampling frequency products. When the DAC operates at a sampling frequency fₛ on a signal with bandwidth B, the DAC generates sidebands at multiples of fₛ, with each sideband having a bandwidth of B. The sidebands exhibit a sinc roll-off factor, where the amplitude of each sideband decreases according to a sinc function envelope. The DAC non-idealities may be modeled with a function A that characterizes the spectral content of the DAC output including the main signal and the sideband images.

The frequency-domain representation of the fast phase shifter signal may be derived by considering the periodic nature of the phase toggling. The time-domain signal created by the fast phase shifter may be extended to account for the periodic toggling by modeling the signal using convolution of a single period with an impulse train. The extended time-domain representation may be expressed as:

$${f}_{n} ( t ) = {\sum }_{v = 0}^{V - 1} {e}^{j {Φ}_{n v}} {\sum }_{i = - ∞}^{∞} ( {Π}_{{T}_{s}^{′}} ( t - v {T}_{s}^{′} - \frac{{T}_{s}^{′}}{2} ) * δ ( t - i V {T}_{s}^{′} ) ) .$$

Herein, the convolution with the impulse train δ(t-iVT′ₛ) creates the periodic repetition of the single-period waveform with period VT′ₛ.

The frequency-domain representation of the fast phase shifter signal Fₙ(f) may be derived by applying the Fourier transform to the extended time-domain expression. The frequency-domain representation may be expressed as:

$${F}_{n} ( f ) = {\sum }_{v = 0}^{V - 1} \frac{1}{V} {e}^{j {Φ}_{n v}} {\sum }_{i = - ∞}^{∞} δ ( f - \frac{i}{V {T}_{s}^{′}} ) {e}^{- j \frac{2 π i}{V {T}_{s}^{′}} ( {vT}_{s}^{′} + \frac{{T}_{s}^{′}}{2} )} sin c ( \frac{i}{V} ) .$$

The frequency-domain representation shows that the fast phase shifter signal consists of impulses located at frequencies i/(VT′ₛ)=if′ₛ/V, weighted by the sinc function and phase terms. The impulse train in the frequency domain results from the periodic nature of the fast phase shifter toggling in the time domain.

The radiated signal from the n-th antenna in the frequency domain may be determined by convolving the DAC output spectrum with the fast phase shifter frequency response. The radiated signal Yₙ(f) may be expressed as:

$${Y}_{n} ( f ) = {\sum }_{v = 0}^{V - 1} \frac{1}{V} {e}^{j {Φ}_{n v}} \times {\sum }_{i = - ∞}^{∞} A ( Z ( f ) ) {\vert}_{f = f - \frac{i}{V {T}_{s}^{′}}} \times {e}^{- j \frac{2 π i}{V {T}_{s}^{′}}} sin c ( \frac{i}{V} ) .$$

The radiated signal expression indicates that the spectrum includes the DAC output spectrum and shifted versions of the DAC output spectrum located at frequencies i/(VT′ₛ). The shifted versions result from the time-variant phase shifting operation performed by the fast phase shifters. Each shifted version is weighted by the sinc function evaluated at i/V and includes phase terms from the fast phase shifter configuration.

The bandpass filter removes all sidebands outside the bandwidth B centered at the carrier frequency f_{c}. The DAC image artifacts are located at frequencies if′ₛ=iVfₛ. For values of i that are multiples of V (i= . . . , −2V, −V, 0, V, 2V, . . . ), the images are shifted into the passband of the bandpass filter. However, for these values of i that are multiples of V, the sinc function sinc (i/V) evaluates to zero for all values except i=0. At i=0, the sinc function equals unity and the DAC output A(Z(f)) approximates Z(f) within the passband.

For values of i that are not multiples of V, the shifted spectral components fall outside the passband of the bandpass filter and are attenuated by the bandpass filter response. The combination of the sinc function zeros at multiples of V and the bandpass filter attenuation of non-passband components results in elimination of the spectral spreading effects from the fast phase shifter switching combined with the DAC non-idealities.

The output of the bandpass filter demonstrates that the fast phase shifter switching combined with DAC non-idealities may be eliminated using the bandpass filter. The filtered radiated signal retains the desired signal components within the bandwidth B centered at f_{c} while removing the sideband images and spectral spreading artifacts. The elimination of non-idealities through bandpass filtering enables the PhaseMO architecture to achieve signal quality comparable to traditional beamforming architectures while utilizing the single RF chain with time-variant phase shifting.

The embodiments described in FIGS. 2B and 3 correspond to a downlink scenario that uses a digital-to-analog converter (DAC). Similar mathematical descriptions and explanations are straightforwardly derivable for the uplink scenario, in which an analog-to-digital converter (ADC) is used instead of the DAC and a sample de-interleaving operation is performed in lieu of the sample interleaving operation performed by sample interleaver 220 and 320 in FIGS. 2B and 3, respectively. More specifically, and in an example, the following operations can be performed to implement the disclosed technology in the uplink scenario:

1. Each of the N antennas feeds an FPS that cycles through V phase settings within each symbol period, implementing a time-variant analog combiner Φ_{N×V} on the incoming passband signals to create V phase-coded sub-intervals per symbol at the array input. This is the receive-side dual of the transmit-side FPS beamforming shown in FIG. 3 (which was implemented as the analog precoder 340).

2. Per-antenna bandpass filters suppress out-of-band components induced by time-variant phase modulation and other RF non-idealities before low-noise amplification, analogous to the transmit-side use of bandpass filters to clean DAC/FPS artifacts and power amplifiers prior to radiation by the N antennas.

3. The time-variant FPS network maps the N filtered antenna signals into a single analog stream Y (f) whose V interleaved sub-intervals encode the V virtual RF chains; this is the receive dual of the transmit mapping ∧Y=Φ_{N×V} Γ_{V×K} X_{K×1}, now acting as an analog combiner prior to downconversion.

4. The combined passband signal is downconverted to baseband and digitized by a single ADC running at the multiple of the base sampling frequency (Vfs) so that each of the V sub-intervals per symbol is sampled at 1/V of the ADC period, exactly dual to the DAC oversampling used in downlink. This preserves the timing required for virtual-chain separation.

5. A digital de-interleaver reorders the high-rate ADC sample stream into V baseband sequences \hat{P}1, . . . ,\hat{P}V, inverting the transmit-side sample interleaving z[n]=[p1[1], . . . ,pV[1],p1[2], . . . ], and yielding V virtual RF chains at baseband for subsequent per-subcarrier processing.

6. A frequency-selective digital combiner (e.g., ZF/MMSE) operates across the V virtual RF chains to separate K users, mirroring the digital precoder Γ_{V×K}(f) used in downlink but in receive form. The end-to-end uplink expression is analogous to the downlink model with Φ_{N×V} followed by a digital linear operator on the V streams, which generates the K user data streams. In some embodiments, the operation of the digital combiner and equalizer includes channel estimation in which H_{K×N}(f) is estimated under time-variant combining.

The above-described uplink scenario, which uses the same time-variant combining and oversampling principles as in the downlink scenario, is scalable but constrained by the V-scaling trade-offs (e.g., ADC sampling rate, FPS speed, and bandwidth).

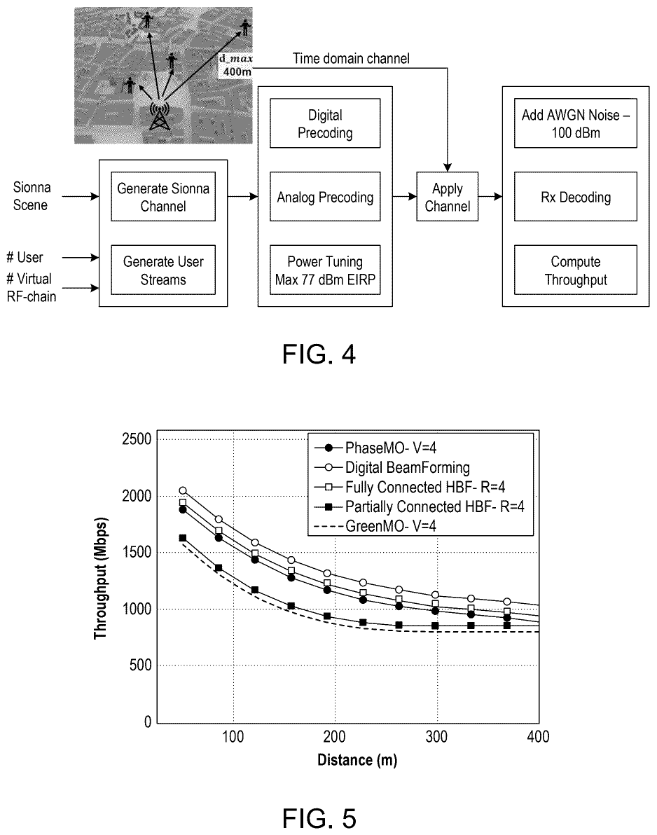

FIG. 4 shows an example evaluation setup using Sionna channel in MATLAB. As shown therein, the evaluation setup depicts a wireless communication scenario in an urban environment with a base station and multiple users distributed at varying distances from the base station. The evaluation framework comprises several interconnected processing blocks that model the signal flow from transmission to reception.

The Sionna channel simulation utilizes a GPU-accelerated open-source library for link-level simulations that generates wideband channel frequency response in an open environment model. The open environment model includes buildings of various sizes to simulate realistic urban propagation conditions. The Sionna scene representation shows an aerial view of an urban environment with buildings and multiple users positioned at different locations relative to a base station antenna. The users are single-antenna user equipment devices distributed at varying distances from the base station, with a maximum distance of 400 meters from the base station indicated in the evaluation setup.

With continued reference to FIG. 4, the base station may be configured at a height of 35 meters and equipped with 64 antennas operating at 4.2 GHz center frequency. The Sionna simulation identifies all beams that may reach the users from the base station and determines the channel impulse response, which includes multiple taps with different phases and attenuations. The simulation obtains channel information for each subcarrier based on parameters such as the center frequency, number of subcarriers, and subcarrier spacing. In some cases, the system may use 64 subcarriers with 100 MHz bandwidth for channel characterization.

The Sionna scene feeds into a Generate Sionna Channel block that produces time-domain channel information for the simulation. The Generate Sionna Channel block processes the urban environment geometry and user positions to compute the wireless channel characteristics between the base station antennas and each user. The channel information accounts for path loss, multipath propagation, and building reflections in the urban environment.

User configuration parameters including the number of users and the number of virtual RF chains are provided to a Generate User Streams block. The Generate User Streams block creates the data streams for each user that will be transmitted through the system. In some cases, the user data may be shaped using 64-QAM constellation points for modulation.

As further shown in FIG. 4, the signal processing chain includes a Digital Precoding block that performs baseband digital precoding on the user data streams. The Digital Precoding block applies a precoding matrix to the user data vectors to generate precoded signals for transmission. In some cases, the Digital Precoding block may apply Zero Forcing equalization based on the channel per subcarrier derived from the Sionna channel information.

An Analog Precoding block follows the Digital Precoding block and applies phase shifts to the digitally precoded signals. The Analog Precoding block implements the phase shifter network that performs analog beamforming on the precoded signals. In some cases, the Analog Precoding block may use the center subcarrier channel phase as the analog beamforming approach for determining phase configurations.

A Power Tuning block ensures compliance with a maximum effective isotropic radiated power (EIRP) limit of 77 dBm for the transmitted signals. The Power Tuning block adjusts the signal power levels to satisfy regulatory constraints while maximizing the transmitted power within the allowed limits. The power tuning operation conditions the amplified signals to avoid violating the maximum EIRP limit.

The precoded and power-tuned signals are passed through an Apply Channel block that applies the Sionna-generated channel effects to simulate over-the-air transmission. The Apply Channel block multiplies the transmitted signals by the channel matrix to model the propagation through the wireless channel between the base station antennas and the users. The channel application accounts for the frequency-selective fading characteristics captured by the Sionna channel model.

Following channel application, an Add AWGN Noise block introduces additive white Gaussian noise at a level of negative 100 dBm to model realistic receiver conditions. The Add AWGN Noise block adds thermal noise to the received signals to simulate the noise floor present in practical receiver implementations. The noise addition enables evaluation of signal-to-interference-plus-noise ratio performance under realistic operating conditions.

On the receiver side, an Rx Decoding block processes the received signals to recover the transmitted data. The Rx Decoding block performs equalization and demodulation operations to extract the user data from the noisy received signals. The error vector magnitude of the received 64-QAM constellation may be computed to derive the user signal-to-interference-plus-noise ratio.

A Compute Throughput block calculates the system throughput based on the decoded signals, enabling performance evaluation of different beamforming techniques. The Compute Throughput block maps the signal-to-interference-plus-noise ratio to spectral efficiency using a 5G-NR modulation and coding scheme table. The spectral efficiency values are then converted to net throughput by considering the total bandwidth used for transmission. The throughput computation is repeated for different distances from the base station and averaged over multiple different user configurations to obtain statistically meaningful performance metrics.

FIGS. 5, 6A-6B and 7A-7D show results of numerical simulations that demonstrate the efficacy of the disclosed embodiments in comparison to existing and prior art beamforming systems and methods.

FIG. 5 shows the net throughput for different beamforming architectures in fixed number of users (e.g., 4) network. The throughput performance evaluation results shown in FIG. 5 compare PhaseMO with various beamforming architectures as a function of distance from the base station. The evaluation considers a network configuration with four users and compares net throughput performance across digital beamforming, fully connected hybrid beamforming with four RF chains, partially connected hybrid beamforming with four RF chains, PhaseMO with four virtual RF chains, and GreenMO with four virtual RF chains.

All throughput curves demonstrate decreasing throughput as distance from the base station increases, which is consistent with expected signal attenuation over distance in wireless propagation environments. The throughput reduction with increasing distance results from path loss, reduced signal-to-interference-plus-noise ratio at the receiver, and the corresponding reduction in achievable spectral efficiency based on the 5G-NR modulation and coding scheme mapping.

As shown in FIG. 5, digital beamforming exhibits the highest throughput performance across all distances evaluated. The digital beamforming architecture utilizes a number of RF chains equal to the number of antennas, providing full digital precoding capability with frequency-dependent precoding across all subcarriers. The frequency-selective precoding capability of digital beamforming enables optimization of the precoding matrix for each subcarrier based on the channel conditions, resulting in improved throughput performance compared to architectures with analog precoding components that apply frequency-flat phase shifts.

PhaseMO with four virtual RF chains achieves throughput performance comparable to fully connected hybrid beamforming with four physical RF chains. The throughput curves for PhaseMO and fully connected hybrid beamforming exhibit similar characteristics across the evaluated distance range, with PhaseMO throughput values positioned slightly below fully connected hybrid beamforming. The comparable throughput performance demonstrates that PhaseMO may achieve hybrid beamforming-equivalent performance while utilizing a single physical RF chain with time-variant phase shifting to create virtual RF chains.

As further shown in FIG. 5, partially connected hybrid beamforming and GreenMO exhibit lower throughput values compared to fully connected hybrid beamforming and PhaseMO. The partially connected hybrid beamforming architecture connects each RF chain to a subset of antennas rather than all antennas, which reduces the beamforming gain available per RF chain compared to fully connected architectures. GreenMO utilizes RF switches to multiplex multiple antennas via a single RF chain using time domain codes, but the switching-based approach provides antenna-selection-based beamforming gains rather than the co-phased combining gains achievable with phase shifter-based architectures.

The throughput evaluation accounts for signal-to-interference-plus-noise ratio degradation due to bandpass filter insertion loss in the PhaseMO architecture. The bandpass filter insertion loss consideration reflects the filtering requirements for removing spectral spreading effects from the fast phase shifter switching operation. The evaluation considers 40-45 dB adjacent channel power ratio attenuation requirements for C-band communications when determining the filter characteristics and associated insertion loss.

The throughput results demonstrate that PhaseMO provides a viable alternative to fully connected hybrid beamforming for achieving spatial multiplexing with reduced RF chain count. The single physical RF chain architecture of PhaseMO reduces hardware complexity compared to hybrid beamforming architectures that require multiple physical RF chains with associated digital-to-analog converters, upconverters, and analog network components. The comparable throughput performance between PhaseMO and fully connected hybrid beamforming indicates that the time-variant phase shifting approach may effectively create virtual RF chains that provide equivalent spatial multiplexing capability to physical RF chains in hybrid beamforming systems.

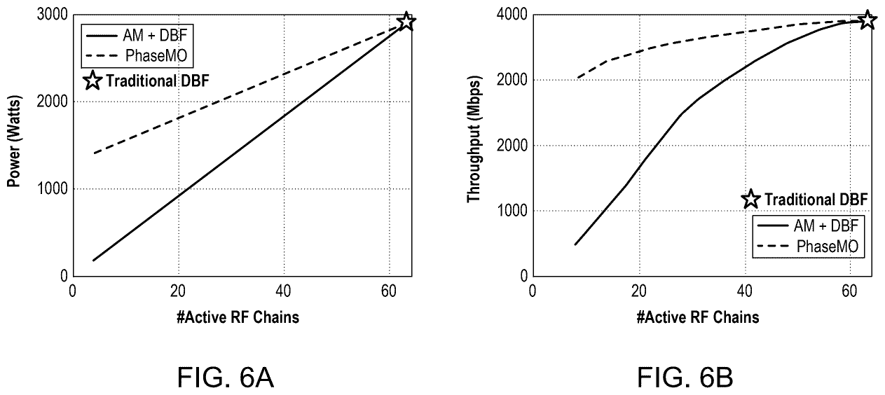

FIGS. 6A and 6B show power consumption and throughput, respectively, of antenna muting combined with digital beamforming and PhaseMO versus different numbers of unmuted/virtual RF chains for 8 users.

Referring to FIG. 6A, the power consumption evaluation considers a base station configuration with 64 antennas and evaluates power consumption as the number of active or virtual RF chains varies from approximately 10 to 60. The power consumption is measured in Watts and plotted on the vertical axis, with the number of active RF chains shown on the horizontal axis.

The total power consumption of a base station is dominated by power amplifier power consumption and baseband processing power consumption. Power amplifier power consumption may be calculated based on the number of active RF chains, the power amplifier output power defined based on the maximum EIRP limit, and the power amplifier efficiency. In some cases, the power amplifiers may operate with 60% power efficiency, with output power of each power amplifier based on a maximum EIRP of 77 dBm. The baseband processing power consumption may be evaluated based on computational requirements per RF chain. The baseband processing power consumption is calculated at 15 GFLOPS per active or virtual RF chain, with each RF chain requiring 1.683 W for baseband processing operations.

With continued reference to FIG. 6A, the antenna muting combined with digital beamforming curve exhibits a steeper increase in power consumption as the number of active RF chains increases. The steeper power consumption increase results from both power amplifier power consumption and baseband processing power consumption scaling with the number of active RF chains in the antenna muting approach. When RF chains are muted in the antenna muting approach, both the associated power amplifiers and the baseband processing for those RF chains are deactivated, resulting in power savings proportional to the number of muted RF chains.

The PhaseMO curve shows a more gradual increase in power consumption as the number of virtual RF chains increases. In PhaseMO, reducing the number of virtual RF chains reduces baseband processing power consumption while maintaining all power amplifiers active. The power amplifiers remain active in PhaseMO because all antennas continue to radiate signals regardless of the number of virtual RF chains, with the single physical RF chain driving all antennas through the fast phase shifter network. The power consumption difference between antenna muting combined with digital beamforming and PhaseMO reflects the different power scaling characteristics of the two approaches.

Both power consumption curves converge at approximately 3000 Watts when all RF chains are active, corresponding to the full digital beamforming configuration with 64 active RF chains. At the maximum RF chain count, both approaches operate with equivalent power consumption since all power amplifiers and all baseband processing resources are active in both configurations.

As further shown in FIG. 6A, PhaseMO may achieve approximately 5-7% power savings compared to full-capability digital beamforming when all antennas are active. The power savings in PhaseMO result from the reduced baseband processing requirements when operating with fewer virtual RF chains than the total number of antennas. The single physical RF chain architecture of PhaseMO reduces the digital processing overhead compared to digital beamforming architectures that require separate digital processing paths for each antenna.

Referring to FIG. 6B, throughput comparison results are illustrated between antenna muting combined with digital beamforming and PhaseMO across varying numbers of active RF chains. The throughput evaluation considers a network configuration with 8 users and measures net throughput in megabits per second on the vertical axis, with the number of active RF chains shown on the horizontal axis.

The PhaseMO curve demonstrates higher throughput values across the evaluated RF chain range compared to antenna muting combined with digital beamforming. The PhaseMO throughput reaches approximately 4000 megabits per second and maintains relatively stable performance as the number of virtual RF chains increases. The stable throughput performance of PhaseMO results from maintaining all antennas active regardless of the number of virtual RF chains, which preserves the full beamforming gain of the antenna array.

With continued reference to FIG. 6B, the antenna muting combined with digital beamforming curve shows lower throughput values that increase more gradually with the number of active RF chains. The lower throughput in antenna muting combined with digital beamforming results from the reduced number of active antennas when RF chains are muted. The reduction in active antennas decreases the overall antenna gain and reduces the spatial multiplexing capability of the system, leading to reduced user-perceived throughput.

Both throughput curves converge at the maximum number of RF chains where traditional digital beamforming operates with all 64 RF chains active. At the full RF chain configuration, both approaches achieve equivalent throughput since all antennas are active and full digital precoding capability is available in both configurations.

The throughput comparison shown in FIG. 6B demonstrates that PhaseMO maintains throughput performance while reducing power consumption through reduced baseband processing. In contrast, antenna muting combined with digital beamforming achieves power reduction at the cost of throughput degradation due to the reduced number of active antennas. The throughput maintenance capability of PhaseMO results from the architecture utilizing all antennas through the fast phase shifter network while reducing the number of virtual RF chains for baseband processing efficiency.

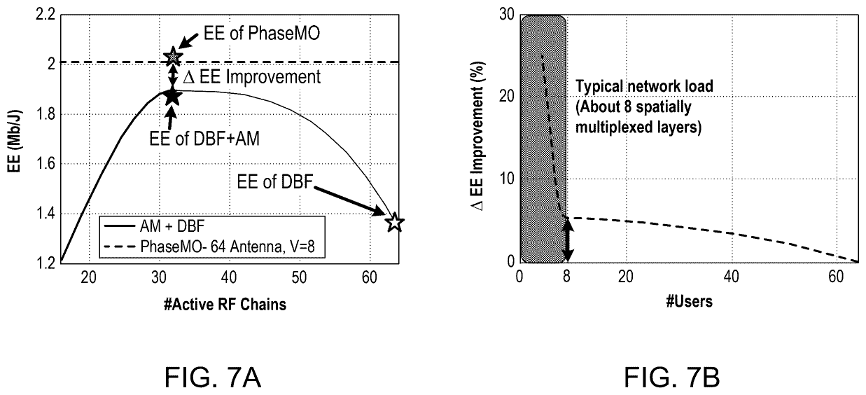

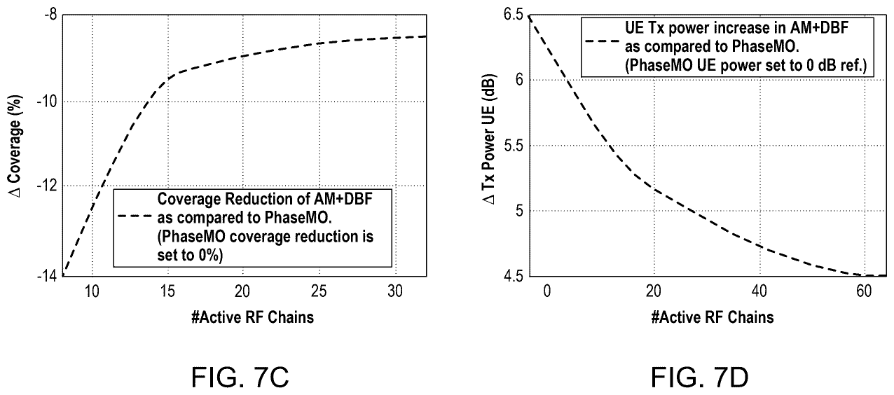

FIGS. 7A to 7D show numerical results that enable the evaluation of which technique (or method) works better in terms of saving power while keeping a reasonable throughput.

Referring to FIG. 7A, energy efficiency comparison results are illustrated between antenna muting combined with digital beamforming and PhaseMO as a function of the number of active RF chains (on the horizontal axis). The energy efficiency metric (on the vertical axis) combines both power consumption and throughput parameters to evaluate the overall efficiency of each beamforming approach. Energy efficiency is measured in megabits per joule, representing the amount of data transmitted per unit of energy consumed by the base station.

As shown in FIG. 7A, the antenna muting combined with digital beamforming curve exhibits a characteristic shape that increases from lower energy efficiency values at fewer active RF chains, reaches a peak at approximately 30 active RF chains, and then decreases as the number of active RF chains increases toward 60. The peak in the antenna muting combined with digital beamforming curve represents an optimum operating point where the tradeoff between power savings from muting RF chains and throughput reduction from reduced antenna count achieves maximum energy efficiency. At RF chain counts below the optimum point, the throughput reduction from muting antennas outweighs the power savings, resulting in reduced energy efficiency. At RF chain counts above the optimum point, the additional power consumption from activating more RF chains is not offset by proportional throughput gains, also resulting in reduced energy efficiency.

The PhaseMO curve is represented as a dashed horizontal line indicating constant energy efficiency of approximately 2.0 megabits per joule across all numbers of active RF chains. The constant energy efficiency of PhaseMO results from the architecture maintaining all antennas active while scaling the number of virtual RF chains to match network load requirements. The horizontal line representation in FIG. 7A corresponds to PhaseMO operating with 64 antennas and 8 virtual RF chains, demonstrating that PhaseMO maintains consistent energy efficiency regardless of the comparison point on the antenna muting combined with digital beamforming curve.

As further shown in FIG. 7A, PhaseMO achieves energy efficiency improvement compared to the peak energy efficiency of the antenna muting combined with digital beamforming approach. The energy efficiency improvement is indicated in FIG. 7A by the vertical distance between the PhaseMO horizontal line and the peak of the antenna muting combined with digital beamforming curve. The PhaseMO energy efficiency of approximately 2.0 megabits per joule exceeds the peak energy efficiency achieved by antenna muting combined with digital beamforming when operating at the optimum point of approximately 30 active RF chains.

In low-load scenarios with fewer users, PhaseMO may achieve up to 30% energy efficiency improvement compared to antenna muting combined with digital beamforming. The energy efficiency improvement in low-load scenarios results from PhaseMO maintaining full beamforming gain from all antennas while reducing baseband processing power consumption through reduced virtual RF chain count. The antenna muting combined with digital beamforming approach experiences greater throughput degradation in low-load scenarios due to the reduced antenna count, which limits the achievable energy efficiency even with reduced power consumption.

For network configurations with up to 8 users, which corresponds to a typical number of users connected to massive MIMO base stations, PhaseMO achieves at least 5% energy efficiency improvement compared to the optimum operating point for antenna muting combined with digital beamforming. This is illustrated in FIG. 7B, where the 5% energy efficiency improvement for 8 users represents a lower bound on the improvement achievable by PhaseMO, with greater improvements available at lower user counts where the throughput advantage of maintaining all antennas active becomes more pronounced relative to the power savings from reduced baseband processing.

The energy efficiency evaluation demonstrates that PhaseMO provides improved energy efficiency compared to antenna muting combined with digital beamforming across varying network load conditions. The improvement results from PhaseMO maintaining throughput performance through full antenna utilization while achieving power reduction through reduced baseband processing requirements. The combination of maintained throughput and reduced power consumption yields the energy efficiency advantage demonstrated in FIG. 7A.

Referring to FIG. 7C, coverage reduction comparison results (e.g., the delta coverage in percentage on the vertical axis) are illustrated between antenna muting combined with digital beamforming and PhaseMO as a function of the number of active RF chains (on the horizontal axis). The coverage comparison evaluates the reduction in base station coverage area when operating with reduced RF chain counts compared to full digital beamforming operation. The coverage reduction metric is expressed as a percentage change relative to PhaseMO coverage, where PhaseMO coverage reduction is set to zero percent as a reference baseline. In FIG. 7C, the negative percentage values indicate that antenna muting combined with digital beamforming experiences coverage loss compared to PhaseMO across the evaluated range of active RF chains.

With continued reference to FIG. 7C, the coverage reduction curve demonstrates that as the number of active RF chains increases from ten to thirty, the coverage reduction of antenna muting combined with digital beamforming improves from approximately negative fourteen percent toward approximately negative eight percent. At lower numbers of active RF chains, antenna muting combined with digital beamforming experiences more severe coverage reduction because fewer antennas are active to provide beamforming gain toward users at the cell edge. The reduced number of active power amplifiers in the antenna muting approach decreases the total radiated power available for reaching distant users, resulting in a contracted coverage area compared to configurations with more active antennas.

The coverage reduction in antenna muting combined with digital beamforming results from turning off antennas and the associated power amplifiers when RF chains are muted. When antennas are muted, the base station loses the beamforming gain contribution from those antennas, which reduces the effective isotropic radiated power in the direction of users. The reduced effective isotropic radiated power translates directly to reduced coverage range, as users at greater distances from the base station may no longer receive signals with sufficient signal-to-interference-plus-noise ratio to maintain connectivity.

As further shown in FIG. 7C, PhaseMO maintains coverage area by keeping all antennas and all power amplifiers active regardless of the number of virtual RF chains. The PhaseMO architecture reduces baseband processing power consumption by reducing the number of virtual RF chains while continuing to drive all antennas through the fast phase shifter network connected to the single physical RF chain. The maintenance of all active antennas preserves the full beamforming gain of the antenna array, which sustains the coverage area at levels equivalent to full digital beamforming operation.

The coverage comparison demonstrates that antenna muting combined with digital beamforming experiences approximately 8-14% coverage reduction compared to PhaseMO when operating with reduced RF chain counts. The coverage reduction range corresponds to the operating points where antenna muting combined with digital beamforming achieves power savings through muting RF chains. At the optimum energy efficiency operating point of approximately 30 active RF chains identified in FIG. 7A, antenna muting combined with digital beamforming experiences approximately 8% coverage reduction compared to PhaseMO. The coverage reduction increases to approximately 14% when fewer RF chains are active, corresponding to more aggressive power saving configurations.

Referring to FIG. 7D, user equipment transmit power (e.g., delta transmit power of user equipment in decibels on the vertical axis) comparison results are illustrated between antenna muting combined with digital beamforming and PhaseMO as a function of the number of active RF chains (on the horizontal axis). The user equipment transmit power comparison evaluates the increase in uplink transmit power that user equipment devices require to achieve equivalent performance when the base station operates with reduced RF chain counts. The user equipment transmit power metric is expressed in decibels relative to PhaseMO user equipment power, where PhaseMO user equipment power is set to zero decibels as a reference. Herein, positive decibel values indicate that antenna muting combined with digital beamforming requires users to transmit at higher power levels compared to PhaseMO to achieve equivalent uplink performance.

With continued reference to FIG. 7D, the user equipment transmit power curve demonstrates that as the number of active RF chains increases, the required user equipment transmit power increase in antenna muting combined with digital beamforming decreases. At lower numbers of active RF chains, the user equipment transmit power disparity is more pronounced because the base station has fewer active antennas available for receiving uplink signals from user equipment devices.

The increased user equipment transmit power requirement in antenna muting combined with digital beamforming results from the reduced receive antenna gain at the base station when antennas are muted. When the base station operates with fewer active antennas, the spatial combining gain available for uplink reception is reduced, which decreases the effective sensitivity of the base station receiver. To compensate for the reduced base station receive sensitivity, user equipment devices may increase transmit power to maintain the same received signal level at the base station.

As further shown in FIG. 7D, the user equipment transmit power increase ranges from approximately 4.5 decibels to approximately 6.5 decibels across the evaluated range of active RF chains. At the optimum energy efficiency operating point of approximately 30 active RF chains, antenna muting combined with digital beamforming requires approximately 4.5 decibels higher user equipment transmit power compared to PhaseMO. The user equipment transmit power increase reaches approximately 6.5 decibels when fewer RF chains are active, corresponding to configurations where more antennas are muted at the base station.

PhaseMO avoids the user equipment transmit power increase by maintaining all antennas active for both downlink transmission and uplink reception. The fast phase shifter network in PhaseMO connects all antennas to the single physical RF chain, enabling the full antenna array to contribute to uplink signal reception regardless of the number of virtual RF chains configured for downlink transmission. The maintenance of all active antennas preserves the spatial combining gain for uplink reception, which sustains user equipment transmit power requirements at levels equivalent to full digital beamforming operation.

The coverage and user equipment transmit power evaluations demonstrate that PhaseMO avoids approximately 10% coverage reduction and approximately 5 decibels increase in user equipment transmit power compared to antenna muting combined with digital beamforming operating at energy-efficient configurations. The avoidance of coverage reduction and user equipment transmit power increase results from the PhaseMO architecture maintaining all antennas active while achieving power savings through reduced baseband processing associated with fewer virtual RF chains. The combination of maintained coverage area, maintained user equipment transmit power requirements, and improved energy efficiency positions PhaseMO as an approach that achieves power savings without introducing adverse effects on network performance metrics.

As discussed in this patent document, the PhaseMO architecture addresses the technical problems of both antenna muting and hybrid beamforming by enabling software-controlled adaptation of the number of virtual RF chains from 1 to N, where N is the number of antennas. The software control over the number of virtual RF chains allows the PhaseMO architecture to reduce baseband processing power consumption proportional to network load requirements while maintaining all antennas active through the fast phase shifter network. The maintenance of all active antennas preserves the full beamforming gain of the antenna array, which sustains throughput performance, coverage area, and user equipment transmit power requirements at levels equivalent to full digital beamforming operation.

The PhaseMO architecture achieves flexible power reduction by scaling the DAC sampling rate and fast phase shifter toggling frequency proportional to the number of virtual RF chains. When network load is low, the number of virtual RF chains is reduced, which decreases the DAC sampling rate and reduces baseband processing power consumption. When network load increases, the number of virtual RF chains is increased through software control without requiring hardware modifications, enabling the system to scale up to full digital beamforming capability when the number of virtual RF chains equals the number of antennas. The software-controlled scalability of PhaseMO provides future-proof operation that adapts to evolving network demands without hardware upgrades.

Embodiments of the disclosed technology are directed to and can be implemented through the following technical solutions:

S1. A system for wireless communication, comprising: an interleaver (e.g., 220, 320) configured to receive a first plurality of data vectors and perform, at a base sampling frequency, a sample interleaving operation thereon to generate a plurality of interleaved digital samples; a single radio frequency (RF) chain (e.g., 330) comprising a single digital-to-analog converter (e.g., 232, 332) that is configured to convert, at a multiple of the base sampling frequency, the plurality of interleaved digital samples into a plurality of analog samples, wherein the multiple corresponds to a number of virtual RF chains; a plurality of phase shifters (e.g., 240, 340), wherein each phase shifter is configured to receive the plurality of analog samples and apply a time-variant phase shift pattern thereto, wherein the time-variant phase shift pattern cycles through a plurality of phases within a symbol time, wherein a number of the plurality of phases is equal to the number of virtual RF chains; and a plurality of bandpass filters (e.g., 352-n), wherein each bandpass filter is configured to perform a filtering operation on an output of a corresponding phase shifter and generate a corresponding plurality of output samples for transmission using an antenna.

S2. The system of solution S1, comprising: a precoder (e.g., 310) configured to receive a second plurality of data vectors and perform a digital precoding operation thereon to generate the first plurality of data vectors; and a plurality of antennas (e.g., 356-n), wherein the antenna is communicatively coupled to a corresponding bandpass filter, and wherein the antenna is configured to transmit the corresponding plurality of output samples.

S3. The system of solution S2, comprising: a beamforming module, wherein: when the number of virtual RF chains equals a number of the plurality of antennas, the beamforming module is configured to operate as a digital beamformer, when the number of virtual RF chains equals one, the beamforming module is configured to operate as an analog beamformer, and when the number of virtual RF chains is greater than one and less than the number of the plurality of antennas, the beamforming module is configured to operate as a hybrid beamformer.

S4. The system of solution S2, wherein the digital precoding operation is configured to apply a digital precoding matrix to the second plurality of data vectors, wherein the digital precoding matrix has dimensions corresponding to the number of virtual RF chains by a number of users.

S5. The system of solution S4, comprising: an analog precoder (e.g., 340) that includes the plurality of phase shifters and is configured to form an analog precoding matrix having dimensions corresponding to a number of the plurality of antennas by the number of virtual RF chains.

S6. The system of any of solutions S1 to S5, wherein the single RF chain further comprises: an upconverter configured to shift, prior to the plurality of phase shifters receiving the plurality of analog samples, a frequency of a signal comprising the plurality of analog samples from a baseband frequency to a carrier frequency.

S7. The system of any of solutions S1 to S6, wherein each of the plurality of bandpass filters comprises a high-precision narrowband bandpass filter with high out-of-band attenuation, thereby enabling the filtering operation to mitigate (a) non-idealities of the single digital-to-analog converter on the plurality of interleaved digital samples and (b) spectrum spreading effects of the plurality of phase shifters on the plurality of analog samples.

S8. The system of any of solutions S1 to S7, wherein the number of virtual RF chains is software-configurable to adapt to varying network load conditions.

S9. The system of any of solutions S1 to S8, wherein each of the plurality of phase shifters comprises a voltage-controlled circuit configured to provide phase changes at sub-nanosecond speeds.

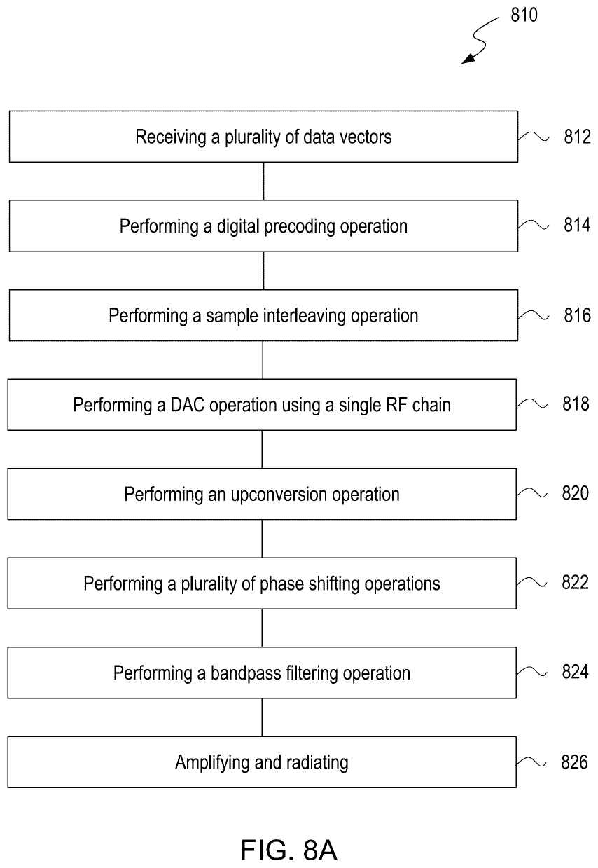

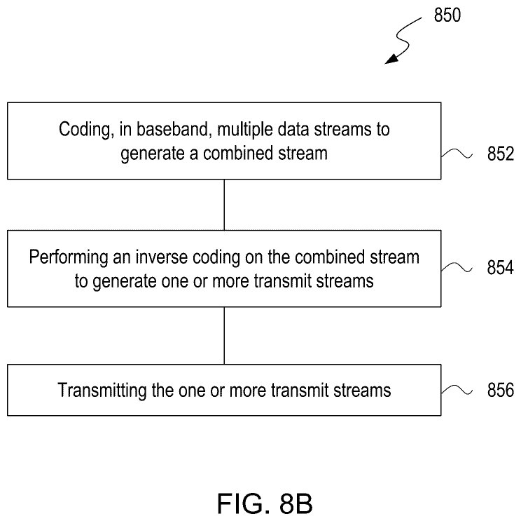

S10. A method (e.g., method 810 shown in FIG. 8A) of wireless communication, comprising: receiving (812) a plurality of data vectors corresponding to a number of users; performing (814) a digital precoding operation on the plurality of data vectors to generate a plurality of precoded signals; performing (816) a sample interleaving operation on the plurality of precoded signals to generate a single interleaved signal, wherein the sample interleaving operation is performed at a base sampling frequency; performing (818), using a single radio frequency (RF) chain, a digital-to-analog conversion (DAC) operation on the single interleaved signal to generate an analog signal, wherein the DAC operation is performed at a multiple of the base sampling frequency, and wherein the multiple corresponds to a number of virtual RF chains; performing (820) an upconversion operation on the analog signal to generate a modulated signal, wherein the upconversion operation comprises shifting a frequency of the analog signal from a baseband frequency to a carrier frequency; performing (822), using a plurality of phase shifters, a plurality of phase shifting operations on the modulated signal to generate a plurality of phase-shifted signals, wherein each phase shifting operation comprises applying a time-variant phase shift pattern to the modulated signal to generate a corresponding phase-shifted signal of the plurality of phase-shifted signals, wherein the time-variant phase shift pattern cycles through a plurality of phases within a symbol time, wherein a number of the plurality of phases is equal to the number of virtual RF chains; performing (824) a bandpass filtering operation on the corresponding phase-shifted signal to generate a corresponding filtered signal of a plurality of filtered signals; and amplifying and radiating (826), using each of a plurality of antennas, the corresponding filtered signal.

S11. The method of solution S10, comprising: adjusting the number of virtual RF chains based on network load conditions.

S12. The method of solution S11, wherein adjusting the number of virtual RF chains comprises: increasing the number of virtual RF chains in response to a network load increasing; and decreasing the number of virtual RF chains in response to the network load decreasing.

S13. The method of any of solutions S10 to S12, comprising: synchronizing phase value transitions of each of the plurality of phase shifters with sampling instants of the DAC operation, wherein the time-variant phase shift pattern comprises holding each phase value for a duration equal to an inverse of the multiple of the base sampling frequency.

S14. The method of any of solutions S10 to S13, wherein the digital precoding operation is based on a digital precoding matrix having dimensions corresponding to the number of virtual RF chains by the number of users.

S15. The method of solution S14, wherein the plurality of phase shifting operations is based on an analog precoding matrix having dimensions corresponding to a number of the plurality of antennas by the number of virtual RF chains.

S16. A base station, comprising: at least one processor coupled to a memory, wherein the at least one processor is configured to: receive a plurality of data vectors corresponding to a plurality of user equipment; perform a digital precoding operation on the plurality of data vectors to generate a plurality of precoded signals; perform a sample interleaving operation on the plurality of precoded signals to generate a single interleaved signal, wherein the sample interleaving operation is performed at a base sampling frequency; perform, based on controlling a single radio frequency (RF) chain, a digital-to-analog conversion (DAC) operation on the single interleaved signal to generate an analog signal, wherein the DAC operation is performed at a multiple of the base sampling frequency, and wherein the multiple corresponds to a number of virtual RF chains; perform an upconversion operation on the analog signal to generate a modulated signal, wherein the upconversion operation comprises shifting a frequency of the analog signal from a baseband frequency to a carrier frequency; perform, based on controlling a plurality of phase shifters, a plurality of phase shifting operations on the modulated signal to generate a plurality of phase-shifted signals, wherein each phase shifting operation comprises applying a time-variant phase shift pattern to the modulated signal to generate a corresponding phase-shifted signal of the plurality of phase-shifted signals, wherein the time-variant phase shift pattern cycles through a plurality of phases within a symbol time, wherein a number of the plurality of phases is equal to the number of virtual RF chains; perform a bandpass filtering operation on the corresponding phase-shifted signal to generate a corresponding filtered signal of a plurality of filtered signals; and controlling each of a plurality of antennas to amplify and radiate the corresponding filtered signal.

S17. The base station of solution S16, wherein the at least one processor is configured to: adjust the number of virtual RF chains based on network load conditions.

S18. The base station of solution S16 or S17, wherein each of the plurality of phase shifters comprises a voltage-controlled circuit configured to provide phase changes at sub-nanosecond speeds.

S19. The base station of any of solutions S16 to S18, wherein the at least one processor is configured, as part of the bandpass filtering operation, to: mitigate, based on using a high-precision narrowband bandpass filter with high out-of-band attenuation, (a) non-idealities of the DAC operation on the single interleaved signal and (b) spectrum spreading effects of the plurality of phase shifters on the modulated signal.

S20. The base station of any of solutions S16 to S19, wherein the at least one processor is configured to: synchronize phase value transitions of each of the plurality of phase shifters with sampling instants of the DAC operation, wherein the time-variant phase shift pattern comprises holding each phase value for a duration equal to an inverse of the multiple of the base sampling frequency.

Embodiments of the disclosed technology are directed to and can be implemented through the following alternative technical solutions:

A1. A system for wireless communication, comprising: an encoder configured to code multiple data streams to generate a combined stream, wherein coding is performed in baseband and each of the multiple data streams is coded using a corresponding distinct code; one or more antennas configured to transmit one or more transmit streams; and an inverting analog logic, coupling the encoder to the one or more antennas, configured to perform an inverse coding on the combined stream to generate the one or more transmit streams, wherein the inverse coding is implemented in an analog domain using delay, phase, or amplitude controls.

A2. The system of solution A1, comprising: a mixer or an upconversion module configured to shift a frequency of the combined stream from a baseband frequency to a carrier frequency.

A3. The system of solution A1, comprising: a power amplifier configured to amplify a corresponding transmit stream prior to transmission by a corresponding antenna.

A4. The system of solution A1, comprising: a bandpass filter configured to filter a corresponding transmit stream, prior to transmission by a corresponding antenna, to remove out-of-band leakage.

A5. The system of solution A1, comprising: a digital-to-analog converter (DAC) configured to convert the combined stream into an analog signal, wherein the inverting analog logic performs the inverse coding on the analog signal to generate the one or more transmit streams.

A6. The system of solution A5, wherein the encoder is implemented in a digital domain, and wherein the encoder comprises: a precoder configured to precode the multiple data streams to generate a plurality of coded streams, wherein a number of the plurality of coded streams corresponds to a number of virtual radio-frequency (RF) chains; a sample interleaver configured to sample the plurality of coded streams to generate the combined stream.

A7. The system of solution A6, wherein the sample interleaver is configured to operate at a base sampling frequency, wherein the DAC is configured to operate at a multiple of the base sampling frequency, and wherein the multiple is equal to the number of virtual RF chains.

A8. The system of solution A6, wherein the number of virtual RF chains is software-configurable to adapt to varying network load conditions.

A9. The system of solution A1, wherein the inverting analog logic comprises a plurality of phase shifters, and wherein each phase shifter comprises a voltage-controlled circuit configured to provide phase changes at sub-nanosecond speeds.

A10. A system for wireless communication, comprising: a plurality of antennas configured to receive multiple streams, wherein each stream is coded in an analog domain using delay, phase, and amplitude controls; a combiner configured to combine the multiple streams to generate a combined stream; a single analog-to-digital converter (ADC) configured to sample the combined stream to generate a digital data stream; and an encoder configured to perform inverse coding on the digital data stream to generate a plurality of digital signals, wherein each of the plurality of digital signals corresponds to one of the multiple streams received on a corresponding antenna of the plurality of antennas.

A11. The system of solution A10, wherein the encoder comprises: a de-interleaver configured to perform a de-interleaving operation on the digital data stream to generate a plurality of baseband streams, wherein a number of the plurality of baseband streams corresponds to a number of virtual radio-frequency (RF) chains; and a digital-domain encoder configured to process the plurality of baseband streams to generate the plurality of digital signals.

A12. The system of solution A11, wherein a sampling frequency of the single ADC is configured based on the number of virtual RF chains.

A13. A method (e.g., method 850 in FIG. 8B) for wireless communication, comprising: coding (852), in baseband, multiple data streams to generate a combined stream, wherein each of the multiple data streams is coded using a corresponding distinct code; performing (854) an inverse coding on the combined stream to generate one or more transmit streams, wherein the inverse coding is implemented in an analog domain using delay, phase, or amplitude controls; and transmitting (856) the one or more transmit streams.

A14. The method of solution A13, comprising: shifting, prior to transmitting the one or more transmit streams, a frequency of the combined stream from a baseband frequency to a carrier frequency.

A15. The method of solution A13, comprising: amplifying, prior to transmitting the one or more transmit streams, a corresponding transmit stream.

A16. The method of solution A13, comprising: performing, prior to transmitting the one or more transmit streams, a bandpass filtering operation on a corresponding transmit stream to remove out-of-band leakage.

A17. The method of solution A13, comprising: converting, using a single digital-to-analog converter (DAC), the combined stream into an analog signal, wherein the inverse coding is performed on the analog signal to generate the one or more transmit streams.

A18. The method of solution A17, comprising: precoding the multiple data streams to generate a plurality of coded streams, wherein a number of the plurality of coded streams corresponds to a number of virtual radio-frequency (RF) chains; and sample interleaving the plurality of coded streams to generate the combined stream.

A19. The method of solution A18, wherein sample interleaving is performed at a base sampling frequency, wherein the single DAC operates a multiple of the base sampling frequency, and wherein the multiple is equal to the number of virtual RF chains.

A20. The method of solution A18, wherein the number of virtual RF chains is software-configurable to adapt to varying network load conditions.

Embodiments of the disclosed technology are directed to and can be implemented through the following alternative technical solutions:

B1. A method for implementing a multi-antenna architecture, comprising: creating, via a network of analog phase shifters, a number V of virtual RF chains configured to interface with a number N of antennas in the multi-antenna architecture, wherein the number V of virtual RF chains is based on a bandwidth B and a symbol time that is based on the bandwidth B; determining analog beam signals to be outputted by the multi-antenna architecture based, at least in part, on sampling V different beam signals created, via the network, within the symbol time; and outputting the analog beam signals using the multi-antenna architecture.

B2. The method of solution B1, wherein the number N of antennas in the multi-antenna architecture is larger than the number V of virtual RF chains.

B3. The method of solution B1, wherein the sampling is performed at a predetermined sampling rate using an analog to digital/digital to analog convertor (ADC/DAC).

B4. The method of solution B3, wherein the number V of virtual RF chains is scalable by modifying the predetermined sampling rate and a run time of the network.

B5. A computer program product comprising instructions, which, when the computer program product is executed by a computer, cause the computer to carry out the method as in any one of solutions B1 to B4.

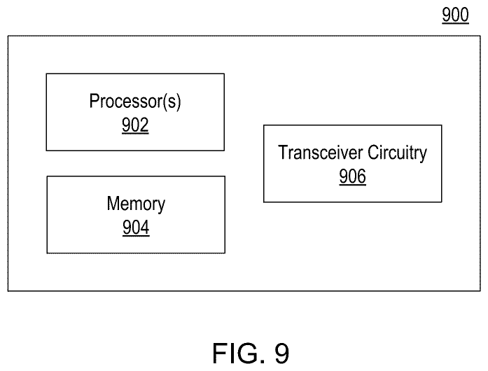

FIG. 9 is a block diagram representation of a wireless hardware platform 900 which may be used to implement the various methods described in the present document. The hardware platform 900 may be incorporated within a base station or a user device (e.g., a wireless device). The hardware platform 900 includes processor electronics including one (or more) processor(s) 902, one or more memories 904 (this may be optional and in some cases the memory may be internal to the processor) and a transceiver circuitry 906. The processor may execute instructions, e. g., by reading from the memory 904, and control the operation of the transceiver circuitry 906 and the hardware platform 900 to perform the methods described herein. In some embodiments, the memory 904 and/or the transceiver circuitry 906 may be partially or completely contained within the processor 902 (e.g., same semiconductor package).

The disclosed embodiments, among other features and benefits, provide a solution to scaling Massive MIMO power consumption flexibly based on network load, while not causing any adverse effect on performance metrics like coverage, throughput and user-device power. This is enabled by disclosed architectures that utilize fast phase shifters (FPSs), capable of providing full array beamforming gain, while reducing the digital interfacing required to optimize levels necessitated by network load conditions. By capturing the full array gain and optimizing for the digital interfacing, some disclosed embodiments can achieve 10-15% better energy efficiency, while keeping performance metrics like coverage and user throughput to the desired peak level of a fully utilized Massive MIMO array.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

Only a few implementations and examples are described, and other implementations, enhancements, and variations can be made based on what is described and illustrated in this patent document. Accordingly, the other implementations are within the scope of the following claims.

What is claimed is:

1. A system for wireless communication, comprising:
an encoder configured to code multiple data streams to generate a combined stream, wherein coding is performed in baseband and each of the multiple data streams is coded using a corresponding distinct code;
one or more antennas configured to transmit one or more transmit streams; and
an inverting analog logic, coupling the encoder to the one or more antennas, configured to perform an inverse coding on the combined stream to generate the one or more transmit streams, wherein the inverse coding is implemented in an analog domain using delay, phase, or amplitude controls.

2. The system of claim 1, comprising:
a mixer or an upconversion module configured to shift a frequency of the combined stream from a baseband frequency to a carrier frequency.

3. The system of claim 1, comprising:
a power amplifier configured to amplify a corresponding transmit stream prior to transmission by a corresponding antenna.

4. The system of claim 1, comprising:
a bandpass filter configured to filter a corresponding transmit stream, prior to transmission by a corresponding antenna, to remove out-of-band leakage.

5. The system of claim 1, comprising:
a digital-to-analog converter (DAC) configured to convert the combined stream into an analog signal, wherein the inverting analog logic performs the inverse coding on the analog signal to generate the one or more transmit streams.

6. The system of claim 5, wherein the encoder is implemented in a digital domain, and wherein the encoder comprises:
a precoder configured to precode the multiple data streams to generate a plurality of coded streams, wherein a number of the plurality of coded streams corresponds to a number of virtual radio-frequency (RF) chains;
a sample interleaver configured to sample the plurality of coded streams to generate the combined stream.

7. The system of claim 6, wherein the sample interleaver is configured to operate at a base sampling frequency, wherein the DAC is configured to operate at a multiple of the base sampling frequency, and wherein the multiple is equal to the number of virtual RF chains.

8. The system of claim 6, wherein the number of virtual RF chains is software-configurable to adapt to varying network load conditions.

9. The system of claim 1, wherein the inverting analog logic comprises a plurality of phase shifters, and wherein each phase shifter comprises a voltage-controlled circuit configured to provide phase changes at sub-nanosecond speeds.

10. A system for wireless communication, comprising:
a plurality of antennas configured to receive multiple streams, wherein each stream is coded in an analog domain using delay, phase, and amplitude controls;
a combiner configured to combine the multiple streams to generate a combined stream;
a single analog-to-digital converter (ADC) configured to sample the combined stream to generate a digital data stream; and
an encoder configured to perform inverse coding on the digital data stream to generate a plurality of digital signals, wherein each of the plurality of digital signals corresponds to one of the multiple streams received on a corresponding antenna of the plurality of antennas.

11. The system of claim 10, wherein the encoder comprises:
a de-interleaver configured to perform a de-interleaving operation on the digital data stream to generate a plurality of baseband streams, wherein a number of the plurality of baseband streams corresponds to a number of virtual radio-frequency (RF) chains; and
a digital-domain encoder configured to process the plurality of baseband streams to generate the plurality of digital signals.

12. The system of claim 11, wherein a sampling frequency of the single ADC is configured based on the number of virtual RF chains.

13. A method for wireless communication, comprising:
coding, in baseband, multiple data streams to generate a combined stream, wherein each of the multiple data streams is coded using a corresponding distinct code;
performing an inverse coding on the combined stream to generate one or more transmit streams, wherein the inverse coding is implemented in an analog domain using delay, phase, or amplitude controls; and
transmitting the one or more transmit streams.

14. The method of claim 13, comprising:
shifting, prior to transmitting the one or more transmit streams, a frequency of the combined stream from a baseband frequency to a carrier frequency.

15. The method of claim 13, comprising:
amplifying, prior to transmitting the one or more transmit streams, a corresponding transmit stream.

16. The method of claim 13, comprising:
performing, prior to transmitting the one or more transmit streams, a bandpass filtering operation on a corresponding transmit stream to remove out-of-band leakage.

17. The method of claim 13, comprising:
converting, using a single digital-to-analog converter (DAC), the combined stream into an analog signal, wherein the inverse coding is performed on the analog signal to generate the one or more transmit streams.

18. The method of claim 17, comprising:
precoding the multiple data streams to generate a plurality of coded streams, wherein a number of the plurality of coded streams corresponds to a number of virtual radio-frequency (RF) chains; and
sample interleaving the plurality of coded streams to generate the combined stream.

19. The method of claim 18, wherein sample interleaving is performed at a base sampling frequency, wherein the single DAC operates a multiple of the base sampling frequency, and wherein the multiple is equal to the number of virtual RF chains.

20. The method of claim 18, wherein the number of virtual RF chains is software-configurable to adapt to varying network load conditions.
